(19) United States
(12) Patent Application Publication
(10) Pub. No.: US 2017/0200398 A1
(43) Pub. Date: Jul. 13, 2017

(54) Producing Method of a Tooth Model for Clinic Practice

(71) Applicants: Hsuan-Chang Chen, Tainan City (TW); Tuan-Ti Hsu, Tainan City (TW); Wen-Hsin Chang, Taichung City (TW); Wei-Yun Lai, Taichung City (TW); Chi-Jr Hung, Taichung City (TW)

(72) Inventors: Hsuan-Chang Chen, Tainan City (TW); Tuan-Ti Hsu, Tainan City (TW); Wen-Hsin Chang, Taichung City (TW); Wei-Yun Lai, Taichung City (TW); Chi-Jr Hung, Taichung City (TW)

(21) Appl. No.: 15/403,230

(22) Filed: Jan. 11, 2017

(30) Foreign Application Priority Data
Jan. 12, 2016 (TW) 105100855

(51) Int. Cl. G09B 23/28; G09B 23/30; B33Y 80/00; B28B 1/00; B33Y 10/00; B33Y 50/00; G09B 9/00; B29C 67/00

(52) U.S. Cl. CPC G09B 23/283; G09B 9/00; G09B 23/30; B29C 67/0059; B29C 67/0088; B28B 1/001; B33Y 10/00; B33Y 50/00; B33Y 80/00; B29K 2067/04

(57) ABSTRACT

A producing method of a tooth model for clinic practice having steps of: obtaining a tooth data, wherein the tooth data comprises inner and outer appearance and size of a real tooth; 3D printing a semi-finished tooth model according to the tooth data by using a first material and a second material, the first and second material is cured by light when 3D printing; wherein the semi-finished tooth model has a tooth body, a tooth pulp portion and a sacrificial portion; the tooth body is covered by the sacrificial portion and the tooth pulp portion is covered by the tooth body; the tooth body and the tooth pulp portion having a crown part at the top and a least one root part at the bottom of the semi-finished tooth model; the tooth pulp portion is in tube shape which is gradually contracted from the crown part to the root part; the tooth body is printed by using the first material and the tooth pulp portion and the sacrificial portion are printed by using the second material; the first material has greater mechanical property than the second material; removing the sacrificial portion and the tooth body exposing from the semi-finished tooth model; and depositing a third material outside the crown part of the tooth body to form an enamel layer, wherein the third material has greater mechanical property than the first material.

### BACKGROUND OF THE INVENTION

1. Field of the Invention

Present invention is related to a producing method of a tooth model, and more particularly to produce the tooth model simulated from a real human tooth for clinic practice.

2. Description of Related Art

Dental treatment like endodontic therapy is mainly practiced by using a dental device to open a decayed tooth, remove decayed dental pulp in a pulp cavity of the decayed tooth, and then enlarge and fix the pulp cavity to fill in an endodontic filler material in treated pulp cavity.

With reference to FIG. 9, a conventional tooth model 10 for dental students practicing endodontic therapy is shown. The conventional tooth model 10 is manufactured by CNC (Computer Numerical Control) machinery which is produced by forming two openings 11 on front side and bottom side of a bulk material and connecting the two openings 11 by drilling a hollow tunnel 12 there between. The hollow tunnel 12 is simulated as pulp cavity of real tooth, so dental students may dig the conventional tooth model 10 from one opening 11 to another through the hollow tunnel 12 to practice the endodontic therapy properly.

Since the conventional tooth model 10 is produced by CNC machinery, it cannot have dental pulp in hollow tunnel 12 as real tooth and the hollow tunnel 12 can be only produced in regularly shape because of manufacturing limitation which is unlike the real pulp cavity. Thus, the conventional tooth model 10 is unable to provide realistic texture or cavity structure as real tooth for dental practice. As producing by the CNC machinery, the conventional tooth model 10 is expensive and cannot be produced customized with actual texture and structure of real tooth.

### SUMMARY OF THE INVENTION

To overcome the shortcomings of the conventional tooth model, the present invention provides a producing method of a tooth model for dental practice to mitigate or obviate the aforementioned problems. The main objective of the present invention is to provide a producing method of a tooth model simulating textures and structure of real tooth for clinic practice.

The producing method of a tooth model for clinic practice comprises steps of: obtaining a tooth data, wherein the tooth data comprises inner and outer appearance and size of a real tooth; 3D printing a semi-finished tooth model according to the tooth data by using a first material and a second material, the first and second material is cured by 3D printing light source, wherein the semi-finished tooth model has a tooth body, a tooth pulp portion and a sacrificial portion, the tooth body is covered by the sacrificial portion and the tooth pulp portion is covered by the tooth body. The tooth body and the tooth pulp portion has a crown part at the top and a least one root part at the bottom of the semi-finished tooth model. The tooth pulp portion is in tube shape which is gradually contracted from the crown part to the root part. The tooth body is printed by using the first material and the tooth pulp portion and the sacrificial portion are printed by using the second material. The first material has greater mechanical property than the second material; removing the sacrificial portion and the tooth body exposing from the semi-finished tooth model; and depositing a third material outside the crown part of the tooth body to form an enamel layer, wherein the third material has greater mechanical property than the first material.

According to the above description, the present invention has advantages as following.

1. The present invention is simulated as real human tooth containing layers with different texture and structure which are able to provide more realistic and accuracy feelings to the dental students for practicing dental treatments. Dental student can actually to learn how to remove second material from unknown shape cavity, which is pretty much like real tooth.

2. By utilizing 3D printing process, the present invention is able to be produced in low cost comparing to CNC manufacture and also can be customized produced.

### BRIEF DESCRIPTION OF THE DRAWINGS

FIG. 1 is a flow chart of a producing method of a tooth model in accordance with the present invention;

FIG. 2 is a flow chart of 3D printing a semi-finished tooth model in accordance with the present invention;

FIG. 3 is a cross sectional side view of the semi-finished tooth model in accordance with the present invention;

FIG. 4 is a cross sectional side view of the tooth model in accordance with the present invention;

FIG. 5 is an operational cross sectional side view of the tooth model in accordance with the present invention, when practicing a endodontic therapy;

FIG. 6 is a bar diagram of young's modulus of the tooth model in accordance with the present invention;

FIG. 7 is a surface SEM observation result of the tooth model in accordance with the present invention which is untreated by depositing a third material thereon;

FIG. 8 is a surface SEM observation result of the tooth model in accordance with the present invention which is treaded by depositing the third material thereon; and

FIG. 9 is a perspective view of a conventional tooth model.

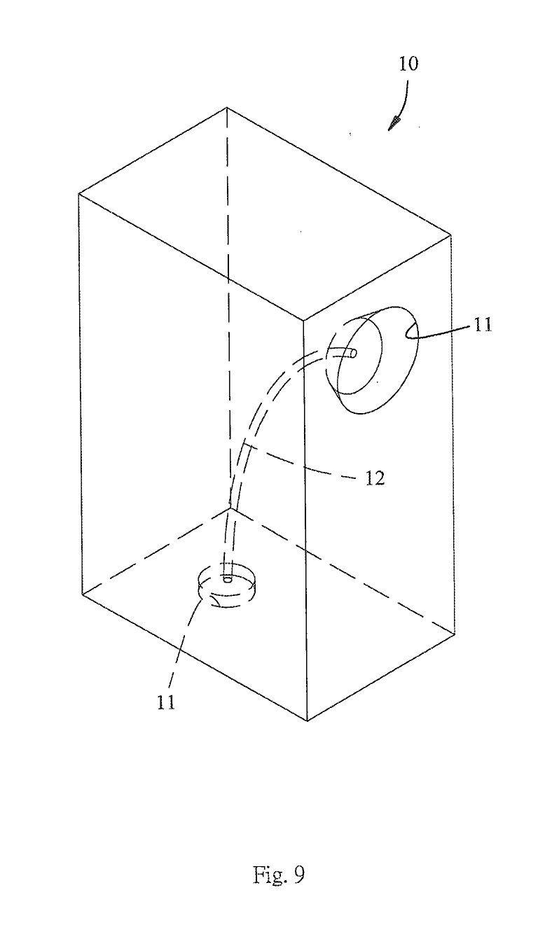

### DETAILED DESCRIPTION OF THE PREFERRED EMBODIMENT

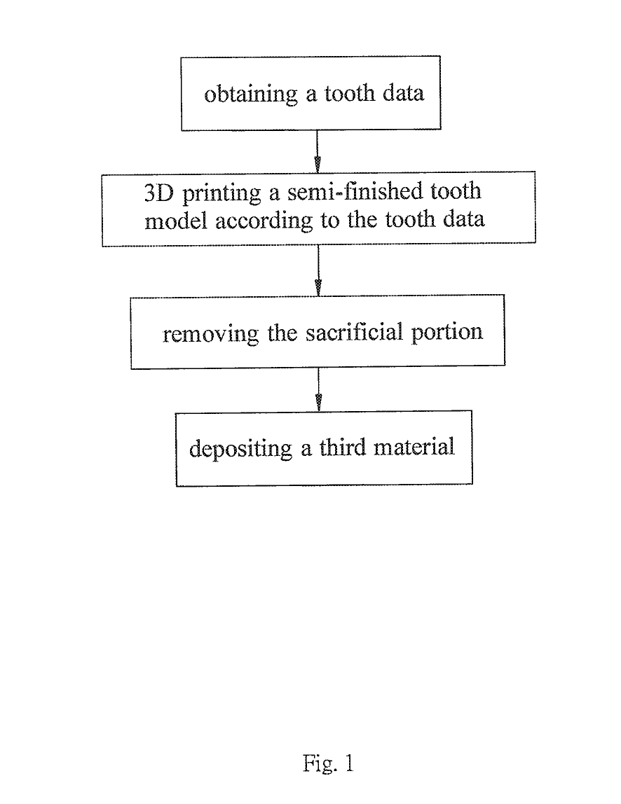

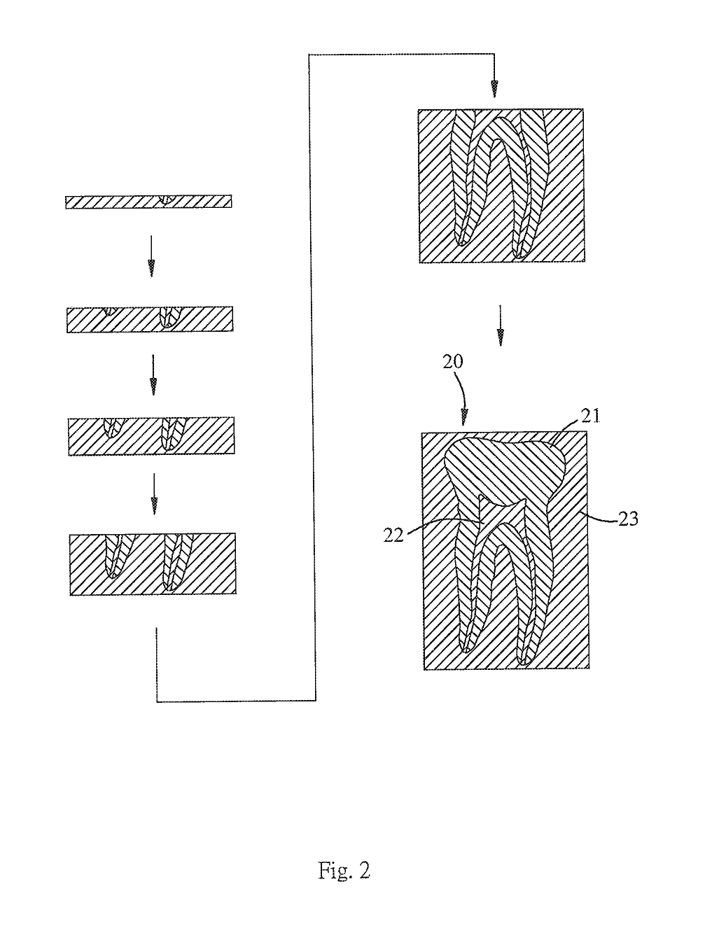

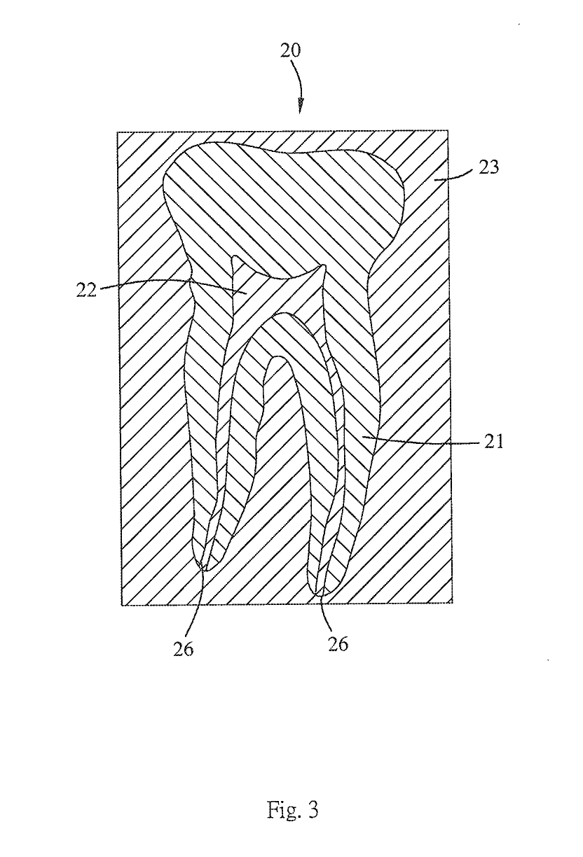

With reference to FIG. 1-3, a producing method of a tooth model simulated from a real human tooth has steps of:

Step 1: obtaining a tooth data which the tooth data comprises inner and outer appearances and sizes of the real human tooth (not shown in figures);

Step 2: 3D printing a semi-finished tooth model 20 according to the tooth data by using a first material and a second material. The first and second material is cured by 3D printing light source.

The semi-finished tooth model 20 has a tooth body 21, a tooth pulp portion 22 and a sacrificial portion 23. The tooth body 21 is covered by the sacrificial portion 23. The tooth pulp portion 22 is covered by the tooth body 21. The tooth body 21 and the tooth pulp portion 22 have a crown part 24 at the top and a least one root part 25 at the bottom of the semi-finished tooth model 20. The tooth pulp portion 22 is in tube shape which is gradually contracted from the crown part 24 to the root part 25. The tooth body 21 is produced by using the first material. The tooth pulp portion 22 and the sacrificial portion 23 are produced by using the second material. The first material has greater mechanical property than the second material. An apical foramen 26 may be further formed on the bottom of the root part 25 to expose the tooth pulp portion 22 outside the tooth body 21 just like real tooth.

The semi-finished tooth model 20 may be produced by a 3D printer with multi-nozzles, such like PolyJet®. By spraying the first material and the second material onto a holding tray and then exposing the first material and the second material with UV light, the semi-finished tooth model 20 will be cured and produced on the holding tray.

Step 3: removing the sacrificial portion 23 to let the tooth body 21 expose from the semi-finished tooth model 20; and

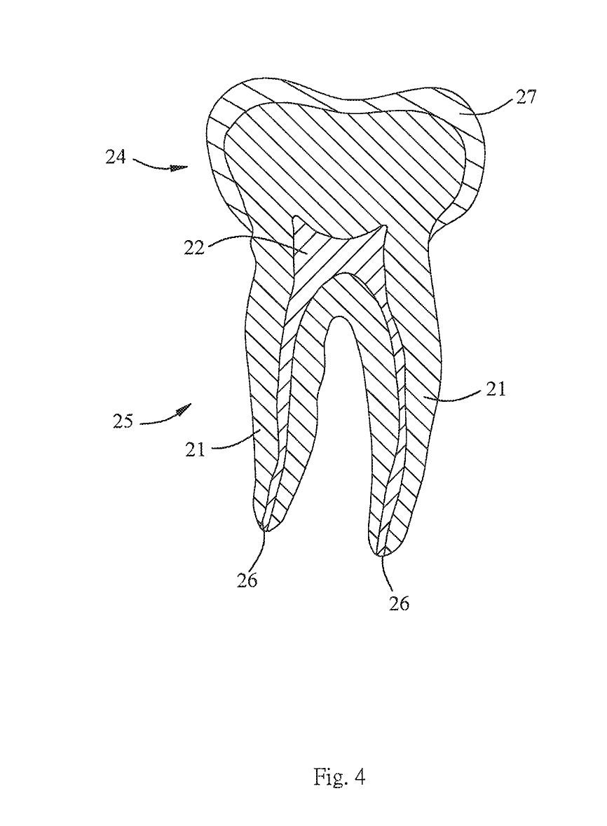

Step 4: depositing a third material outside the crown part 24 of the tooth body 21 to form an enamel layer 27. With reference to FIGS. 1 and 4, the third material is deposited on the crown part 24 of the tooth body after removing the sacrificial portion 23. The third material has greater mechanical property than the first material. Preferably, the mechanical property of the third material is at least 1.5 times greater than the first material. Said mechanical property may be but not limited to hardness, tensile strength, anti-impact strength and the like.

The first material and the second material of the present invention are 3D printable materials and are able to be cured by light source of 3D printing. The first material and the second material have different level of curing abilities and mechanical properties. The first material and the second material may be medical graded plastic like PLA, PLGA, PCL or PU. The first material is preferably a translucent or transparent material which may allow the tooth pulp portion 21 be see-through from the tooth body 21. Dental students are able to clearly observe how treatment goes inside the tooth body 21 when practicing the endodontic therapy.

To have different level of curing abilities and mechanical properties, the first material and the second material may have different content of light curing agent if the first material and the second material are the same material. The first material and the second material may also be different material which is already having different curing abilities and mechanical properties.

The second material not only can be 3D printed, cured by light, but also can be dissolved in certain solvent like water or other organic solvent. Thus, aforementioned step 4 may be achieved by placing the semi-finished tooth model 20 into certain solvent which the second material as the sacrificial portion 23 is able to be dissolved and removed from the tooth body 21 of the present invention.

The reason why the sacrificial portion 23 is preferred to be used is that the sacrificial portion 23 may provide or enhance accuracy and resolution for 3D printing when forming a three-dimensional structure. Thus, the sacrificial portion 23 is applied for creating the tooth model with three-dimensional structure of the present invention. Since the sacrificial portion 23 may be dissolved in solvent, so it can be easily removed after 3D-printing process.

The third material may be a hydroxyapatite (CaHPO₄) being deposited on the crown part 24 of the tooth body 21 of the present invention. Aforementioned step 5 may be achieved by firstly forming nucleus on the surface of crown part 24 of the tooth body 21 and then immersing the crown part 24 of the tooth body 21 in a supersaturated biomimetic solution containing mainly calcium, phosphate and hydroxyl ions in it. The ions in the biomimetic solution may cause chemical reaction with the crown part 24 of the tooth body 21 to form the enamel layer 27 of the present invention. After chemical reaction is finished, the tooth body 21 is washed by d₂H₂O to remove residuals of the biomimetic solution and dried by an oven.

The supersaturated biomimetic solution is preferably prepared by gradually dissolving NaCl (58.444 g), KCl (0.375 g), CaCl₂.2H₂O (1.016 g), MgCl₂.6H₂O (3.675 g) and NaH₂PO₄.H₂(1.198 g) in d₂H₂O (900 mL) and then adjusting the pH value of entire solution to pH=4.1.

The hydroxyl ion of the chemical reaction may partially come from the biomimetic solution and partially come from the first material of the crown part 24 of the tooth body 21. The first material of 3D printable materials like PLA, PLGA, PCL or PU of the present invention have hydroxyl functional group which may perform as hydroxyl ion to deposit with calcium ion and phosphate ion in the biomimetic solution. This may cause interlayer formed between the enamel layered 27 and the crown part 24 of the tooth body 21.

Since the surface of the crown part 24 of the tooth body 21 may contain some tiny gaps, slits or interfaces that come from 3D printing, the third material may have more surface or space to directly deposit onto the surface of the crown part 24 of the tooth body 21. The aforementioned nucleus can be considered unnecessary.

Thus, the enamel layered 27 and the crown part 24 of the tooth body 21 may securely attached or binding to each other just as real tooth. The enamel layered 27 of the present invention will not so easily to fall out from the crown part 24 of the tooth body 21 which may provide more realistic feelings to the dental students when practicing endodontic therapy.

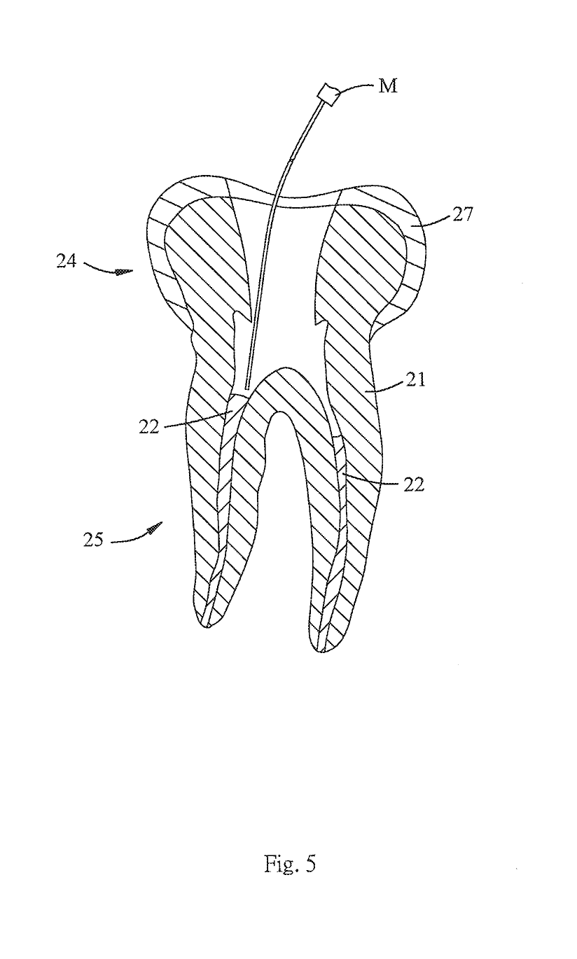

With reference to FIG. 5, the present invention have structure and appearance simulated from real tooth by 3D-printing which may allow the dental students practice dental treatment more realistically. The dental students may practice dental treatments by using a dental device M to dig, clean, fix or fill the tooth pulp portion 22 of the present invention. Since the present invention is simulated as real human tooth containing layers with different texture and structure, the present invention is able to provide more realistic and accuracy feelings to the dental students for practicing dental treatments.

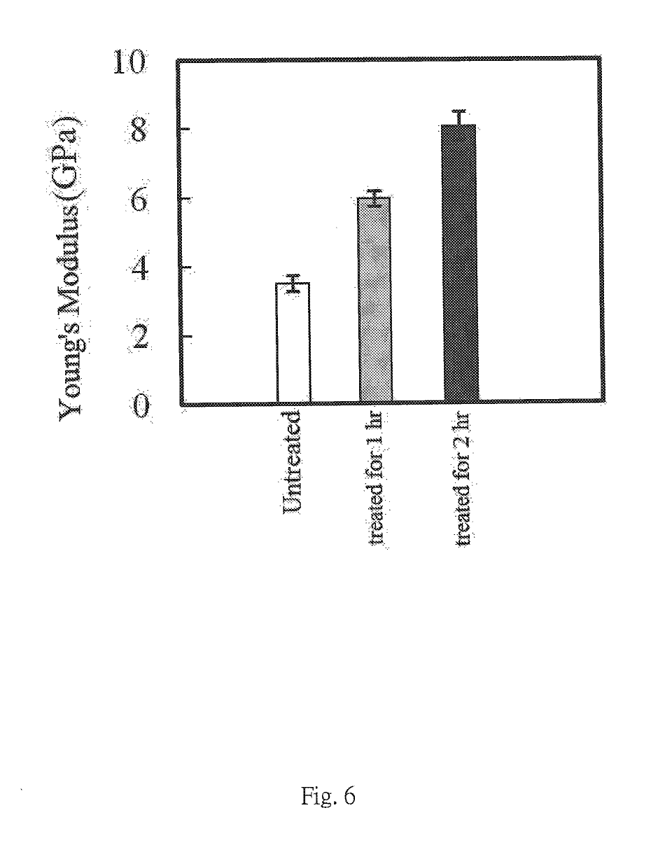

With reference to FIG. 6 and below chart 1, young's modulus of the present inventions is at least 1.5 times greater than the tooth body 21 after the third material being deposited onto the tooth body 21 for 1-2 hours. The present invention can even achieve consistent young's modulus comparing to the tooth enamel of real tooth.

| | CHART 1 |
|---|---|
| | Young's modulus (GPa) |
| Tooth body of the present invention | 3 |
| The third material depositing for 1 hr | 5~60 |
| The third material depositing for 2 hrs | 8~90 |

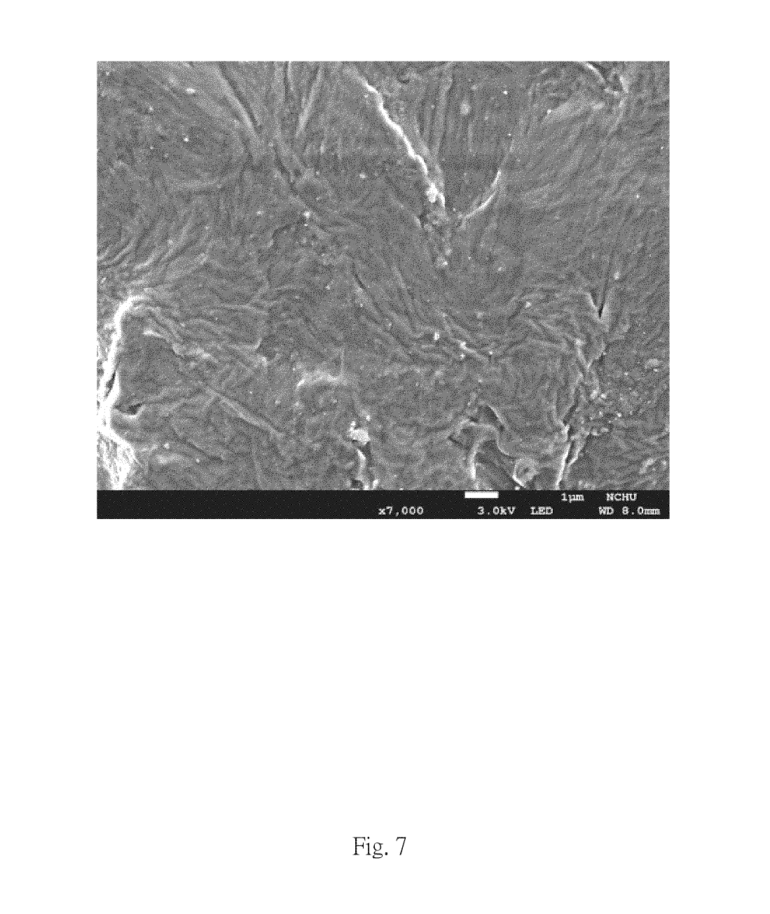

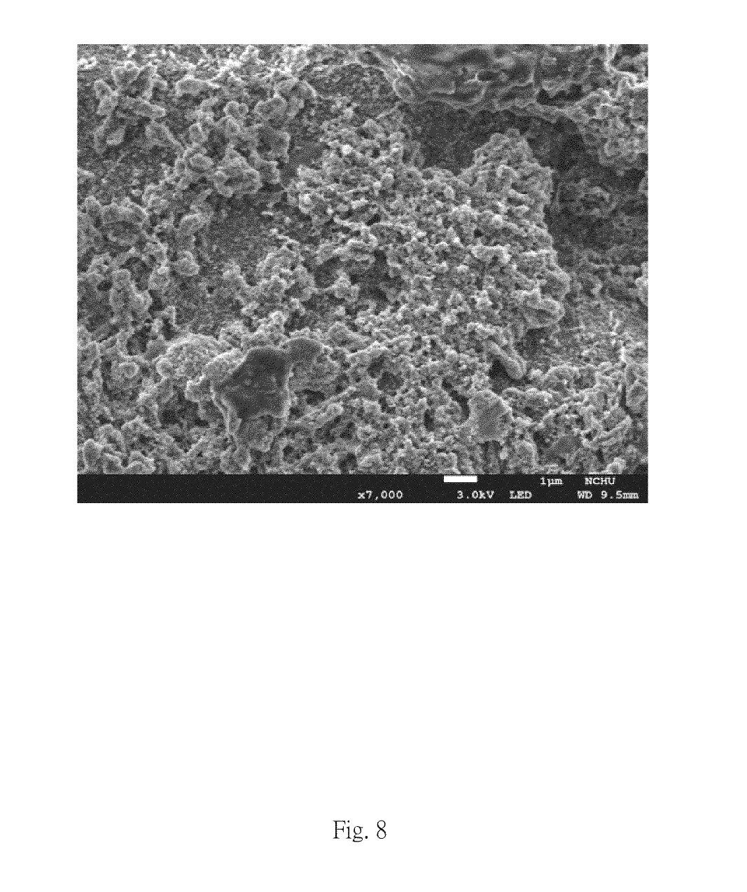

With reference to FIG. 7-8, FIG. 7 shows surface SEM observation result of the tooth body 21 before the third material being deposited. FIG. 8 further shows surface SEM observation result of the tooth body 21 after depositing the third material thereon for 2 hours. FIG. 8 shows great amount of hydroxyapatite deposited on the surface of the tooth body 21.

According to the above description, the present invention has advantages as following.

1. The present invention is simulated as real human tooth containing layers with different texture and structure which are able to provide more realistic and accuracy feelings to the dental students for practicing dental treatments. Dental student can actually to learn how to remove second material from unknown shape cavity, which is pretty much like real tooth.

2. By utilizing 3D printing process, the present invention is able to be produced in low cost comparing to CNC manufacture and also can be customized produced.

Other objectives, advantages and novel features of the invention will become more apparent from the following detailed description when taken in conjunction with the accompanying drawings.

What is claimed is:

1. A producing method of a tooth model for clinic practice comprising steps of:
step 1: obtaining a tooth data, wherein the tooth data comprises inner and outer appearance and size of a real tooth;
step 2: 3D printing a semi-finished tooth model according to the tooth data by using a first material and a second material, the first and second material is cured by light when 3D printing; wherein
the semi-finished tooth model has a tooth body, a tooth pulp portion and a sacrificial portion;
the tooth body is covered by the sacrificial portion and the tooth pulp portion is covered by the tooth body;
the tooth body and the tooth pulp portion having a crown part at the top and a least one root part at the bottom of the semi-finished tooth model;
the tooth pulp portion is in tube shape which is gradually contracted from the crown part to the root part;
the tooth body is printed by using the first material and the tooth pulp portion and the sacrificial portion are printed by using the second material;
the first material has greater mechanical property than the second material;
step 3: removing the sacrificial portion and the tooth body exposing from the semi-finished tooth model; and
step 4: depositing a third material outside the crown part of the tooth body to form an enamel layer, wherein the third material has greater mechanical property than the first material.

2. The producing method of a tooth model for clinic practice as claimed in claim 1, wherein the mechanical property of the third material is at least 1.5 times greater than the first material.

3. The producing method of a tooth model for clinic practice as claimed in claim 1, wherein obtaining the tooth data by CT scanning.

4. The producing method of a tooth model for clinic practice as claimed in claim 1, wherein the first material is PLA, PLGA, PCL or PU.

5. The producing method of a tooth model for clinic practice as claimed in claim 1, wherein removing the sacrificial portion by dissolving the second material in a solvent.

6. The producing method of a tooth model for clinic practice as claimed in claim 1, wherein the first material is translucent or transparent.

7. The producing method of a tooth model for clinic practice as claimed in claim 1, wherein depositing the third material by immersing the crown part of the tooth body in a biomimetic solution.

8. The producing method of a tooth model for clinic practice as claimed in claim 7, wherein forming nucleus onto the crown part of the tooth body before deposing the third material.

9. The producing method of a tooth model for clinic practice as claimed in claim 7, wherein the biomimetic solution is supersaturated.

10. The producing method of a tooth model for clinic practice as claimed in claim 8, wherein the biomimetic solution is supersaturated.

11. The producing method of a tooth model for clinic practice as claimed in claim 1, wherein the third material is hydroxyapatite.

12. The producing method of a tooth model for clinic practice as claimed in claim 1, wherein an apical foramen being formed on the bottom of the root part of the tooth body.
